(19) United States
(12) Patent Application Publication
(10) Pub. No.: US 2015/0057089 A1
(43) Pub. Date: Feb. 26, 2015

(54) ITEM COMBINATION METHOD AND SERVER

(71) Applicant: INTELLECTUAL DISCOVERY CO., LTD., Seoul (KR)

(72) Inventor: Seung Hwan Choi, Yongin-Si (KR)

(73) Assignee: INTELLECTUAL DISCOVERY CO., LTD., Seoul (KR)

(21) Appl. No.: 14/386,268

(22) PCT Filed: Dec. 24, 2012
(86) PCT No.: PCT/KR2012/011347

§ 371 Date: Sep. 18, 2014

(30) Foreign Application Priority Data
Jun. 8, 2012 (KR) 10-2012-0061359

(51) Int. Cl. A63F 13/60

(52) U.S. Cl. CPC A63F 13/60
USPC 463/43

(57) ABSTRACT

An item combination method according to an exemplary embodiment of the present invention provided through an item combination server includes: receiving consumable item information from a user terminal using an item combination service capable of obtaining a new item by consuming a plurality of items; analyzing user information corresponding to the user terminal to detect user characteristic information related to a game play; selecting at least one item matched to the detected user characteristic information among the obtainable items as a result of the combination service; and selecting any one item among at least one selected item according to a predetermined probability to be provided to an account of the user.

### TECHNICAL FIELD

The present invention relates to an item combination method and a server, and in detail, relates to a technique providing a reward item by periodically determining a demand of a user or a consumption pattern when using an item combination service capable of obtaining a new item by consuming a plurality of items.

### BACKGROUND ART

With the development of communications networks, various online game services have been being provided. Further, as graphics techniques and the performance of user terminals are improved, high-quality game programs are being created. Game contents which provide detailed descriptions for real or visual space have also been being developed.

Accordingly, the user utilization of online games is increased, and the game genres are diversified. Recently, various online games such as sports games, role playing games, and first person shooting games have been most popular.

As one feature of the online games, users can enjoy their favorite online games with each other by simultaneously accessing the same game contents system. The users can individually enjoy the games through cooperation or competition with different users by controlling their characters or the like on the same game screen.

Moreover, in the online games, the users can accomplish one mission by cooperation with different users, or can enjoy game contents by competition with different users. In this case, in the online games, it is necessary to provide contents that rouse a competitive spirit between the users. This is because it is required to have the users continuously access and play the online games by rousing the competitive spirit between the users in order to maintain or increase the user utilization of the online games in terms of their features.

The contents for rousing the competitive spirit between the users may be roughly divided into a level of a user character, an item that can be applied to the user character, a skill implemented by a user, and the like. Particularly, the level and the skill of the user character may be improved by the user while the user plays the game and increases an experience level of the user character.

Among them, in the online game system, a server combining the items is provided. In a conventional online game system, the item combination method is a method of obtaining a reward item corresponding to a pool determined according to a level of the inserted item.

The above information disclosed in this Background section is only for enhancement of understanding of the background of the invention and therefore it may contain information that does not form the prior art that is already known in this country to a person of ordinary skill in the art.

### DISCLOSURE

### Technical Problem

The present invention provides a reward item of a same level by periodically determining a demand of a user or a consumption pattern when using an item combination service capable of obtaining a new item by consuming a plurality of items.

### Technical Solution

An item combination method according to an exemplary embodiment of the present invention includes: receiving consumable item information from a user terminal using an item combination service capable of obtaining a new item by consuming a plurality of items; analyzing user information corresponding to the user terminal to detect user characteristic information related to a game play; selecting at least one item matched to the detected user characteristic information among obtainable items as a result of the combination service; and selecting any one item among at least one selected item according to a predetermined probability to be provided to an account of the user.

The step detecting the user characteristic information may detect information related to at least one among a character level of the user, a tribe, and a play pattern in the game.

The step of selecting at least one item may select the items included in an item group matched to the user characteristic information among the obtainable items grouped into at least one item group matched to at least one piece of predetermined user characteristic information.

The step of detecting the user characteristic information may detect the information of the group including the user among at least one user group grouped according to the user characteristic information.

The step of selecting at least one item may include receiving the detected item consumption pattern information on the game of the group including the user from the game server, and selecting at least one item among the obtainable items by activating the received item consumption pattern information.

The step of selecting at least one item may include detecting the items included in the received item consumption pattern information, and selecting at least one item determined to be satisfied with a predetermined reference related to a consumption frequency of the item among the selected items.

The step of selecting at least one item may include respectively determining a winning probability for at least one selected items according to the consumption frequency of the item, and selecting and providing any one among at least one selected item according to the predetermined winning probability to an account of the user.

An item combination server according to an exemplary embodiment of the present invention includes: a consumption item information input unit receiving consumable item information from a user terminal using an item combination service capable of obtaining a new item by consuming a plurality of items; a characteristic information detection unit analyzing user information corresponding to the user terminal to detect user characteristic information related to a game play; an item selection unit selecting at least one item matched to the detected user characteristic information among the obtainable items as a result of the combination service; and an item providing unit selecting and providing any one item among at least one selected item according to a predetermined probability to an account of the user.

The characteristic information detection unit may detect the user characteristic information related to at least one among a character level of the user, a tribe, and a play pattern in the game.

The item selection unit may select at least one item included in an item group matched to the user characteristic information among the obtainable items grouped into at least one item group matched to at least one piece of predetermined user characteristic information.

The characteristic information detection unit may detect the user characteristic information of the group including the user among at least one user group grouped according to the user characteristic information.

The item selection unit may include a consumption pattern receiver receiving the detected item consumption pattern information on the game of the group including the user from the game server, and at least one item among the obtainable items may be selected by activating the received item consumption pattern information.

The item selection unit may include a consumption item detection unit detecting the items included in the received item consumption pattern information, and at least one item determined to be satisfied with a predetermined reference related to a consumption frequency of the item among the selected items may be selected.

The item selection unit may include a winning probability determining unit respectively determining a winning probability for at least one selected item according to the consumption frequency of the item, and any one among at least one selected item may be selected according to the predetermined winning probability and may be provided to an account of the user.

### Advantageous Effects

According to the present invention, when using the item combination service capable of obtaining a new item by consuming a plurality of items, a reward item of the same level is provided by periodically determining a demand of the user and the consumption pattern, and thereby the users using the combination service increase satisfaction for the reward obtained through the combination method.

Also, the present invention may urge exhaustion of an economic item holding amount in the game through the activation of the combination service.

### DESCRIPTION OF THE DRAWINGS

FIG. 1 is a flowchart of an item combination method according to an exemplary embodiment of the present invention.

FIG. 2 is a function block diagram of a configuration of an item combination server according to an exemplary embodiment of the present invention.

FIG. 3 is a flowchart of an item combination method according to another exemplary embodiment of the present invention.

FIG. 4 is a flowchart of an item combination method according to another exemplary embodiment of the present invention.

FIG. 5 is a flowchart of an item combination method according to another exemplary embodiment of the present invention.

FIG. 6 is a function block diagram of a configuration of an item combination server according to another exemplary embodiment of the present invention.

### MODE FOR INVENTION

Hereinafter, an item combination method and a server according to each exemplary embodiment of the present invention will be described with reference to accompanying drawings.

It is obvious that the following exemplary embodiment is a detailed description which is provided for better understanding of the present invention, and does not limit the scope of the present invention. Therefore, an equivalent invention which performs the same function as the present invention may also be covered by the scope of the present invention.

In adding reference numerals to components of each drawing, even though the same components are illustrated in different drawings, it is to be noted that these components are denoted by the same reference numerals if possible. In describing exemplary embodiments of the present invention, well-known functions or constructions will not be described in detail since they may unnecessarily obscure the understanding of the present invention.

In addition, in describing components of the present specification, terms such as first, second, A, B, (a), (b), etc. may be used. These terms are used only to differentiate the components from other components. Therefore, the nature, times, sequence, etc. of the corresponding components are not limited by these terms. When a component is “connected”, “coupled”, or “linked” to another component, it is to be understood that the component may be directly connected or linked to the other component, but the component may be “connected”, “coupled”, or “linked” to the other component via another component therebetween.

In an exemplary embodiment of the present invention, “communication”, “communication network”, and “network” may be used to have the same meaning. The three terminologies indicate a wired or wireless local area and wide area data transmitting/receiving network through which a file is transmitted/received between a user terminal, another user terminal, and a download server.

In the following description, “game server” indicates a server computer that users access to use game contents. In the case of a game which has a small capacity or a small number of users, a plurality of game programs may be operated by one game server. Further, in the case of a game which has a large capacity or a large number of real time accessing members, one or more game servers which operate one game may be provided depending on a function of the game.

In addition, middleware for databases or servers which perform payment processing may be connected to the game server, but the description thereof will be omitted in the present invention.

Herein, an online game indicates game contents that can be used by users who access the aforementioned game server. Particularly, the online game indicates a game that can be simultaneously accessed and enjoyed by a plurality of users and increase levels of the users by, e.g., acquiring experience levels while rearing characters through playing of the game on the game.

For convenience of description, it is preferable that one example of the online game is a sports game operating at least one character. Accordingly, the user selects an online soccer game and manages the game with a type growing the team selected by the user through a match of the team directed by the user that is a manager of the soccer team and an opposing team. The user selects one among a plurality of nations managing the soccer league to determine a participation league and is provided with a team list included in the participation league to select the team to be directed by the user, and then a match with the opposing team that is randomly selected or by the requirement of the user is required to start the game. Also, a real shape of a real soccer player and a capacity value are reflected to each player included in the team at a maximum to maximize fun of the user.

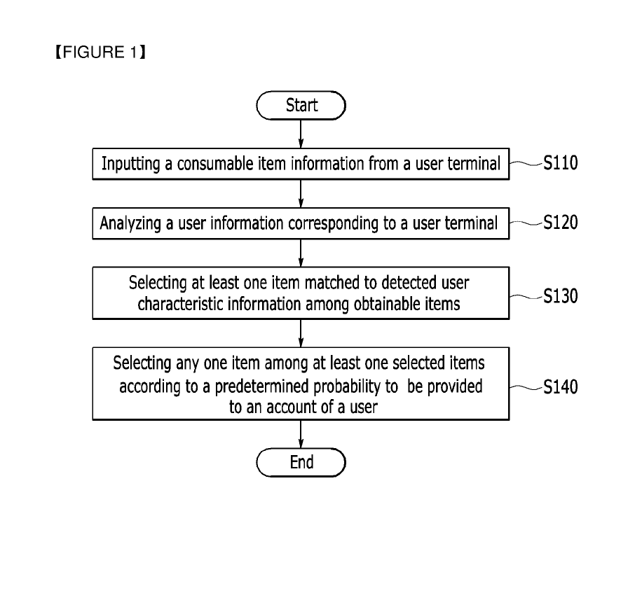

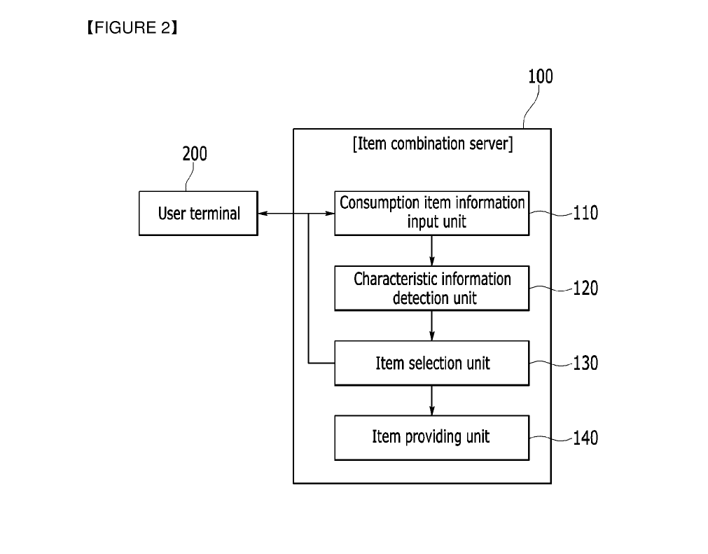

FIG. 1 is a flowchart of an item combination method according to an exemplary embodiment of the present invention, and FIG. 2 is a function block diagram of a configuration of an item combination server according to an exemplary embodiment of the present invention.

As shown in FIG. 1, the item combination method according to an exemplary embodiment of the present invention is performed in an item combination server 100 as shown in FIG. 2 if there is no other performance subject.

Firstly, the item information to be consumed is input from a user terminal 200 using the item combination service capable of obtaining a new item by consuming a plurality of items (S110). For example, in the online soccer game, player cards used as the game character may be combined. Accordingly, five player item cards as the item information are input from the user terminal 200.

Next, the user information corresponding to the user terminal 200 is analyzed to detect the user characteristic information related to the game play (S120). In this case, in the step S120 of detecting the user characteristic information, it is preferable to detect the information related to at least one of a character level of the user, a tribe, and a play pattern in the game. That is, without the information of the player item card input from the user terminal 200, the user information is analyzed to detect the user characteristic information related to the game play.

Next, as a result of the item combination service, among the items capable of being obtained, at least one item matched to the detected user characteristic information is selected (S130). In this case, in the step S130 of selecting at least one item, it is preferable to select the items included in an item group matched to the user characteristic information among the obtainable items grouped into at least one item group matched to at least one piece of predetermined user characteristic information.

For example, the item group may be divided into any one item group among the user character level, the tribe, and the play pattern in the game. Accordingly, in the present invention, when a statistic of the player item card used in the combination, that is, a level, is an average statistic of 1200 and the level of the user is 100, the server selects the item matched to the level 100 of the user in the item group grouped into at least one item matched to the level.

Next, any one item among at least one selected item is selected according to a predetermined probability and is provided to an account of the user (S140).

FIG. 2 is a function block diagram of an item combination server according to an exemplary embodiment of the present invention. As shown in FIG. 2, the item combination server 100 according to an exemplary embodiment of the present invention includes a consumption item information input unit 110, a characteristic information detection unit 120, an item selection unit 130, and an item providing unit 140.

The consumption item information input unit 110 is input with the consumable item information from the user terminal 200 using the item combination service to obtain the new item by consuming a plurality of items. For example, in the online soccer game, the player card available as the game character may be combined. Accordingly, five consumable player item cards of the item information are input from the user terminal 200.

Also, the characteristic information detection unit 120 analyzes the user information corresponding to the user terminal 200 to detect the user characteristic information related to the game play. In this case, in the step S120 of detecting the user characteristic information, it is preferable to detect the information related to at least one among the character level of the user, the tribe, and the play pattern in the game. That is, without the usage of the information of the player item card input from the user terminal 200, the user information is analyzed to detect the user characteristic information related to the game play.

In this case, it is preferable that the characteristic information detection unit 120 detects the information of the group including the user among at least one user group grouped according to the user characteristic information.

The item selection unit 130 selects at least one item matched to the detected user characteristic information among the obtainable items as a result of the item combination service. In this case, it is preferred that the item selection unit 130 selects the items included in the item group matched to the user characteristic information among the obtainable items grouped into at least one item group matched to at least one piece of predetermined user characteristic information. In this case, it is preferred that the item selection unit 130 selects the items included in the item group matched to the user characteristic information among the obtainable items grouped into at least one item group matched to at least one piece of predetermined user characteristic information.

For example, the item group may be divided into any one item group among the user character level, the tribe, and the play pattern in the game. Accordingly, in the present invention, when a statistic of the player item card used to the combination, that is, a level, is an average statistic of 1200 and the level of the user is 100, the server selects the item matched to the level 100 of the user in the item group grouped into at least one item matched to the level.

Also, the item providing unit 140 selects any one item among at least one selected item according to the predetermined probability and provides it to the account of the user.

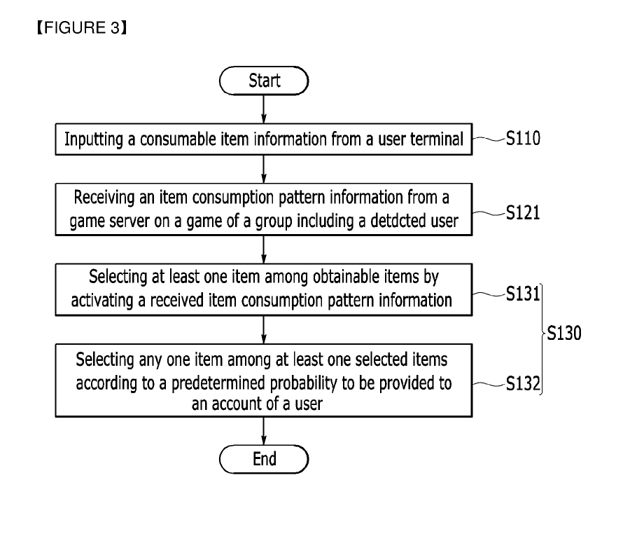

FIG. 3 is a flowchart of an item combination method according to another exemplary embodiment of the present invention. In the following description, the description of the portion overlapping the description for FIG. 1 will be omitted.

As shown in FIG. 3, first, the consumable item information is input from the user terminal 200 using the item combination service capable of obtaining the new item by consuming a plurality of items (S110).

Differently from FIG. 1, in FIG. 3, the detect item consumption pattern information on the game of the group including the user is received from a game server 101 (S121). In this case, the item consumption pattern information means the player item card purchased through an auction by the online game users of the same level, however it is not limited thereto. Here, the online game user may be grouped by the team statistic as well as the level of the user, or the tribe in a case of a MMORPG game. Also, the online game user may be grouped by the user play pattern, in other words, a player's position in a case of the online soccer game.

Next, by activating the received item consumption pattern information, at least one item is selected among the obtainable items (S131). That is, the server selects at least one among the player item cards purchased through the auction by the online game users of the same level.

Next, among at least one selected item, any one item is selected according to the predetermined probability and is provided to the account of the user (S132).

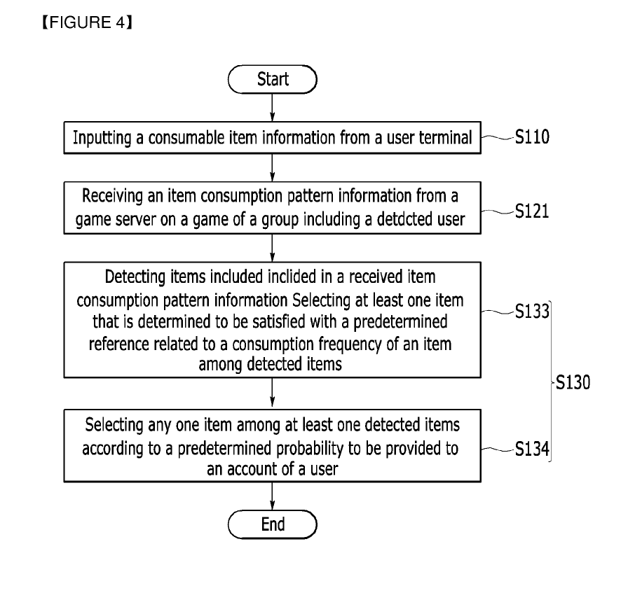

FIG. 4 is a flowchart of an item combination method according to another exemplary embodiment of the present invention. In the following description, the description of the portion overlapping the description for FIG. 1 will be omitted.

First, as shown in FIG. 3, the consumable item information is input from the user terminal 200 using the item combination service capable of obtaining the new item by consuming a plurality of items (S110).

Differently from FIG. 1, in FIG. 4, the detect item consumption pattern information on the game of the group including the user is received from the game server 101 (S121).

On the other hand, in the step S130 of selecting at least one item of the present invention, the items included in the received item consumption pattern information are detected (S133).

Next, at least one item that is determined to satisfy a predetermined reference related to a consumption frequency of the item is selected among the detected items (S134).

Next, among at least one selected item, any one item is selected according to the predetermined probability and is provided to the account of the user (S140).

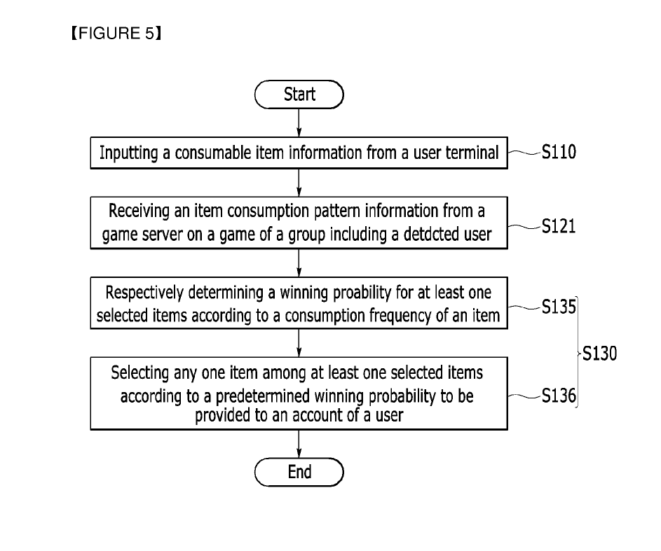

FIG. 5 is a flowchart of an item combination method according to another exemplary embodiment of the present invention. In the following description, the description of the portion overlapping the description for FIG. 1 will be omitted.

As shown in FIG. 5, first, the consumable item information is input from the user terminal 200 using the item combination service capable of obtaining the new item by consuming a plurality of items (S110).

Differently from FIG. 1, in FIG. 5, the detect item consumption pattern information on the game of the group including the user is received from the game server 101 (S121).

On the other hand, in the step S130 of selecting at least one item, a winning probability is respectively determined for at least one selected item according to the consumption frequency of the item (S135).

Next, any one item is selected among at least one selected item according to the predetermined winning probability and is provided to the account of the user (S136).

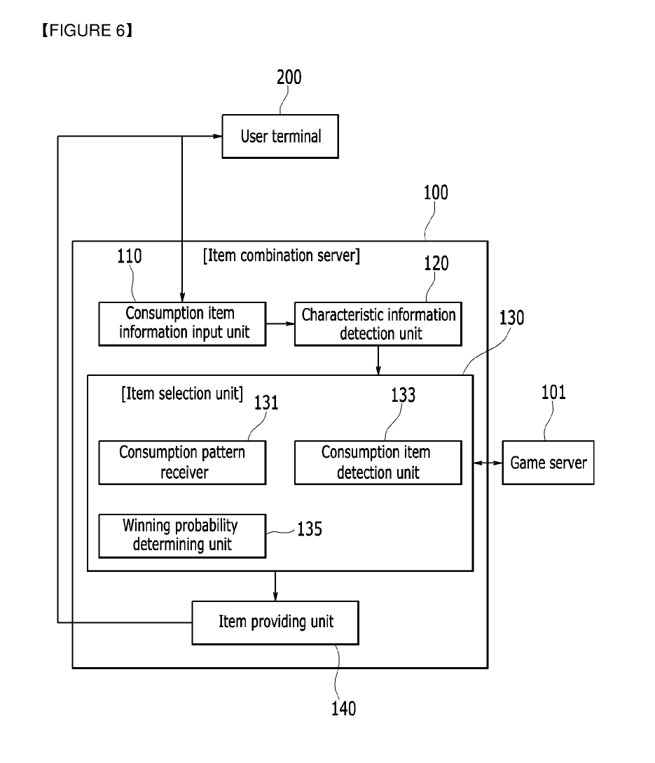

FIG. 6 is a function block diagram of an item combination server according to another exemplary embodiment of the present invention. As shown in FIG. 6, the item selection unit 130 of the item combination server according to the current exemplary embodiment of the present invention may include a consumption pattern receiver 131, a consumption item detection unit 133, and a winning probability determining unit 135.

On the other hand, the consumption pattern receiver 131 of the item selection unit 130 receives the detected item consumption pattern information on the game of the group including the user from the game server 101. As described above, by activating the received item consumption pattern information, it is preferable to select at least one item among the obtainable items.

Next, the consumption item detection unit 133 of the item selection unit 130 detects the items included in the received item consumption pattern information. It is preferable that at least one item that is determined to satisfy a predetermined reference related to the consumption frequency of the item is selected among the selected items.

Also, the winning probability determining unit 135 of the item selection unit 130 respectively determines the winning probability for at least one selected item according to the consumption frequency of the item. Thus, it is preferable that the item selection unit 130 selects any one among at least one selected item according to the predetermined winning probability and provides it to the account of the user as described above.

The item combination method according to an exemplary embodiment of the present invention as described above may be executed by the applications basically installed in the terminal (including programs included in a platform, an operating system, or the like which are basically installed in the terminal), and may also be executed by the applications (i.e., programs) which are directly installed in the terminal by the user via an application store server or a web server associated with the applications or the corresponding services. The item combination method according to an exemplary embodiment of the present invention as described above may be implemented by the applications (i.e., programs) which are basically installed or directly installed by the user in the terminal, and may be recorded in a computer readable recording medium of the terminal and the like.

The programs are recorded in the computer readable recording medium and are executed by the computer, such that the above-mentioned functions may be executed.

As described above, in order for the computer to read the programs recorded in the recording medium and execute the item combination method according to an exemplary embodiment of the present invention, the above-mentioned programs may include codes which are coded with computer languages such as C, C++, JAVA, machine language, and the like which may be read by a processor (CPU) of the computer.

The code may include a function code associated with a function for defining the above-mentioned functions, and may also include an execution procedure related control code required for the processor of the computer to execute the above-mentioned functions according to a predetermined procedure.

Further, the code may include a memory reference related code indicating at which location (address number) of the memory inside or outside the computer additional information or media required for the processor of the computer to execute the above-mentioned functions needs to be referenced.

In addition, in order for the processor of the computer to execute the above-mentioned functions, when the processor needs to communicate with any other computers, servers, etc. at a remote location, the code may further include a communication related code regarding how the processor of the computer communicates with any other computers or servers at a remote location or which information or media the processor of the computer transmits and receives at the time of the communication, by using the communication module (for example, a wired and/or wireless communication module) of the computer.

Further, a functional program for implementing the present invention, a code and a code segment associated therewith, and the like may be easily inferred or changed by programmers in the art to which the present invention pertains in consideration of a system environment of the computer which reads the recording medium and executes the program.

Hereinabove, examples of a computer readable recording medium recorded with programs as described above include a ROM, a RAM, a CD-ROM, a magnetic tape, a floppy disk, an optical media storage device, and the like.

Further, a computer readable recording medium recorded with programs as described above may be distributed to a computer system connected through a network and thus store and execute a computer readable code by a distributed manner. In this case, at least one computer among a plurality of distributed computers may execute a part of the above-mentioned functions and transmit the executed results to at least one of the other distributed computers, and the computer receiving the result may also execute a part of the above-mentioned functions and provide the executed results to the other distributed computers.

In particular, a computer readable recording medium recorded with applications, which are programs for executing the item combination method in accordance with the exemplary embodiments of the present invention, may be a storage medium (for example a hard disk and the like) included in an application store server or an application providing server such as a web server associated with applications or corresponding services, and the like, or the application providing server itself.

A computer, which may read a recording medium recorded with applications that are programs for executing the item combination method in accordance with the exemplary embodiments of the present invention, may include not only a general PC such as a typical desktop and a laptop, but also a mobile terminal such as a smart phone, a tablet PC, a personal digital assistant (PDA), and a mobile communication terminal, and is to be construed as all the computable devices.

When a computer, which may read a recording medium recorded with applications that are programs for executing the method for providing the predict event service of the match result in accordance with the exemplary embodiments of the present invention, is a mobile terminal such as a smart phone, a tablet PC, a personal digital assistant (PDA), and a mobile communication terminal, the applications are downloaded from an application providing server to a general PC and thus may also be installed in the mobile terminal through a synchronization program.

Hereinabove, although it has been mentioned that all components configuring the exemplary embodiment of the present invention described hereinabove are combined with each other as one component or are combined and operated with each other as one component, the present invention is not necessarily limited to the above-mentioned exemplary embodiment. That is, all the components may also be selectively combined and operated with each other as one or more components without departing from the scope of the present invention. In addition, although each of all the components may be implemented by one independent hardware unit, some or all of the respective components which are selectively combined with each other may be implemented by a computer program having a program module performing some or all of functions combined with each other in one or multiple hardware units. The codes and the code segments configuring the computer program may be easily inferred by a person having ordinary skill in the art to which the present invention pertains. The computer programs are stored in the computer readable media and are read and executed by the computer, and may implement the exemplary embodiment of the present invention. As the storage medium of the computer programs, a magnetic recording medium, an optical recording medium, and the like may be used.

In addition, it will be further understood that the term “comprises” or “have” used in this specification may include the corresponding components unless explicitly described to the contrary, and therefore do not preclude other components but may further include other components. In addition, unless defined otherwise in the detailed description, all the terms including technical and scientific terms have the same meaning as meanings generally understood by those skilled in the art to which the present invention pertains. Generally used terms such as terms defined in a dictionary should be interpreted as having the same meanings as those within a context of the related art, and should not be interpreted as having ideally or excessively formal meanings unless clearly defined in the present specification.

The spirit of the present invention has been exemplified. It will be appreciated by those skilled in the art that various modifications and alterations can be made without departing from the essential characteristics of the present invention. Accordingly, the exemplary embodiments disclosed in the present invention do not limit but describe the spirit of the present invention, and the scope of the present invention is not limited by the exemplary embodiments. The scope of the present invention should be interpreted by the following claims, and it should be interpreted such that all spirits equivalent to the following claims fall within the scope of the present invention.

1. An item combination method operated through an item combination server comprising:
receiving consumable item information from a user terminal using an item combination service capable of obtaining a new item by consuming a plurality of items;
analyzing user information corresponding to the user terminal to detect user characteristic information related to a game play;
selecting at least one item matched to the detected user characteristic information among obtainable items as a result of the combination service; and
selecting any one item among at least one selected item according to a predetermined probability to be provided to an account of the user.

2. The item combination method of claim 1, wherein
the step of detecting the user characteristic information detects information related to at least one among a character level of the user, a tribe, and a play pattern in the game.

3. The item combination method of claim 1, wherein
the step of selecting at least one item selects the items included in an item group matched to the user characteristic information among the obtainable items grouped into at least one item group matched to at least one piece of predetermined user characteristic information.

4. The item combination method of claim 1, wherein
the step of detecting the user characteristic information detects the information of the group including the user among at least one user group grouped according to the user characteristic information.

5. The item combination method of claim 4, wherein
the step of selecting at least one item includes:
receiving the detected item consumption pattern information on the game of the group including the user from the game server; and
selecting at least one item among the obtainable items by activating the received item consumption pattern information.

6. The item combination method of claim 5, wherein
the step of selecting at least one item includes:
detecting the items included in the received item consumption pattern information; and
selecting at least one item determined to be satisfied with a predetermined reference related to a consumption frequency of the item among the selected items.

7. The item combination method of claim 6, wherein
the step of selecting at least one item includes:
respectively determining a winning probability for at least one selected items according to the consumption frequency of the item; and
selecting and providing any one among at least one selected item according to the predetermined winning probability to an account of the user.

8. An item combination server comprising:
a consumption item information input unit receiving consumable item information from a user terminal using an item combination service capable of obtaining a new item by consuming a plurality of items;
a characteristic information detection unit analyzing user information corresponding to the user terminal to detect user characteristic information related to a game play;
an item selection unit selecting at least one item matched to the detected user characteristic information among the obtainable items as a result of the combination service; and
an item providing unit selecting and providing any one item among at least one selected item according to a predetermined probability to an account of the user.

9. The item combination server of claim 8, wherein
the characteristic information detection unit detects the user characteristic information related to at least one among a character level of the user, a tribe, and a play pattern in the game.

10. The item combination server of claim 8, wherein
the item selection unit selects at least one item included in an item group matched to the user characteristic information among the obtainable items grouped into at least one item group matched to at least one piece of predetermined user characteristic information.

11. The item combination server of claim 8, wherein
the characteristic information detection unit detects the user characteristic information of the group including the user among at least one user group grouped according to the user characteristic information.

12. The item combination server of claim 11, wherein
the item selection unit includes a consumption pattern receiver receiving the detected item consumption pattern information on the game of the group including the user from the game server, and
at least one item among the obtainable items is selected by activating the received item consumption pattern information.

13. The item combination server of claim 12, wherein
the item selection unit includes a consumption item detection unit detecting the items included in the received item consumption pattern information, and
at least one item determined to be satisfied with a predetermined reference related to a consumption frequency of the item among the selected items is selected.

14. The item combination server of claim 13, wherein
the item selection unit includes a winning probability determining unit respectively determining a winning probability for at least one selected item according to the consumption frequency of the item, and
any one among at least one selected item is selected according to the predetermined winning probability and is provided to an account of the user.

15. A computer readable record media recorded with a program to realized an item combination method through an item combination server,
wherein the item combination method includes: receiving consumable item information from a user terminal using an item combination service capable of obtaining a new item by consuming a plurality of items;
analyzing user information corresponding to the user terminal to detect user characteristic information related to a game play;
selecting at least one item matched to the detected user characteristic information among the obtainable items as a result of the combination service; and
selecting any one item among at least one selected item according to a predetermined probability to be provided to an account of the user.
